(19) United States
(12) Patent Application Publication
(10) Pub. No.: US 2009/0049399 A1
(43) Pub. Date: Feb. 19, 2009

(54) SYSTEM FOR PRESENTING GRAPHICAL USER INTERFACE WINDOWS

(75) Inventor: SCOTT WHITE, AUSTIN, TX (US)

Correspondence Address: AKERMAN SENTERFITT, P.O. BOX 3188, WEST PALM BEACH, FL, 33402-3188, US

(73) Assignee: AT&T KNOWLEDGE VENTURES, L.P., RENO, NV (US)

(21) Appl. No.: 11/837,773

(22) Filed: Aug. 13, 2007

(51) Int. Cl. G06F 3/048

(52) U.S. Cl. 715/781

(57) ABSTRACT

A system that incorporates teachings of the present disclosure may include, for example, a media content processor having a controller to present portions of media content over a plurality of Graphical User Interface (GUI) windows some of which are anchored to each other, adjust a select one of the plurality GUI windows responsive to receiving a dimensional adjustment request, and counter adjust a dimension of at least one of the other anchored GUI windows according to the adjusted dimension of the select GUI window. Other embodiments are disclosed.

### FIELD OF THE DISCLOSURE

The present disclosure relates generally to windowing techniques and more specifically to a system for presenting Graphical User Interface (GUI) windows.

### BACKGROUND

Some sophisticated television sets and media content receivers available today can provide Picture-in-Picture (PiP) window viewing as well as the ability to view video content in one window while viewing an electronic programming guide (EPG) in another. At times the proportions of these windows do not provide the consumer a satisfactory viewing area in either window. For instance, the EPG window may take up too much space away from the window in which a TV program is being viewed and vice-versa. Similar issues can arise for other systems such as computers, personal digital assistants and like devices that provide viewing of media content in multiple windows.

### BRIEF DESCRIPTION OF THE DRAWINGS

FIG. 1 depicts an exemplary embodiment of a communication system;

FIG. 2 depicts an exemplary embodiment of a portal of the communication system;

FIG. 3 depicts an exemplary method operating in portions of the communication system;

FIGS. 4-9 depict exemplary embodiments of graphical user interface (GUI) windows according to the method of FIG. 3; and

FIG. 10 is a diagrammatic representation of a machine in the form of a computer system within which a set of instructions, when executed, may cause the machine to perform any one or more of the methodologies discussed herein.

### DETAILED DESCRIPTION

In one embodiment of the present disclosure, a computer-readable storage medium can have computer instructions for receiving a presentation request for presenting media content over a consumption Graphical User Interface (GUI) window and an interactive GUI window, anchoring a portion of the consumption GUI window to the interactive GUI window, presenting the consumption GUI window and the interactive GUI window, receiving an adjustment request to adjust a select one among the consumption and interactive GUI windows, and adjusting according to the adjustment request a first dimension of the consumption GUI window while counter adjusting a second dimension of the interactive GUI window about the anchored portion.

In one embodiment of the present disclosure, a media content processor can have a controller to present portions of media content over a plurality of GUI windows some of which are anchored to each other, adjust a select one of the plurality GUI windows responsive to receiving a dimensional adjustment request, and counter adjust a dimension of at least one of the other anchored GUI windows according to the adjusted dimension of the select GUI window.

In one embodiment of the present disclosure, a computer-readable storage medium in a portal can have computer instructions for presenting at a portable communication device a plurality of GUI windows some of which have portions of said windows anchored to each other, receiving from the portable communication device a dimensional adjustment request to be applied to a select one of the plurality of GUI windows, and presenting at the portable communication device an adjustment to a dimension of the select GUI window and a counter dimensional adjustment to at least one of the other GUI windows according to the portions anchored therebetween.

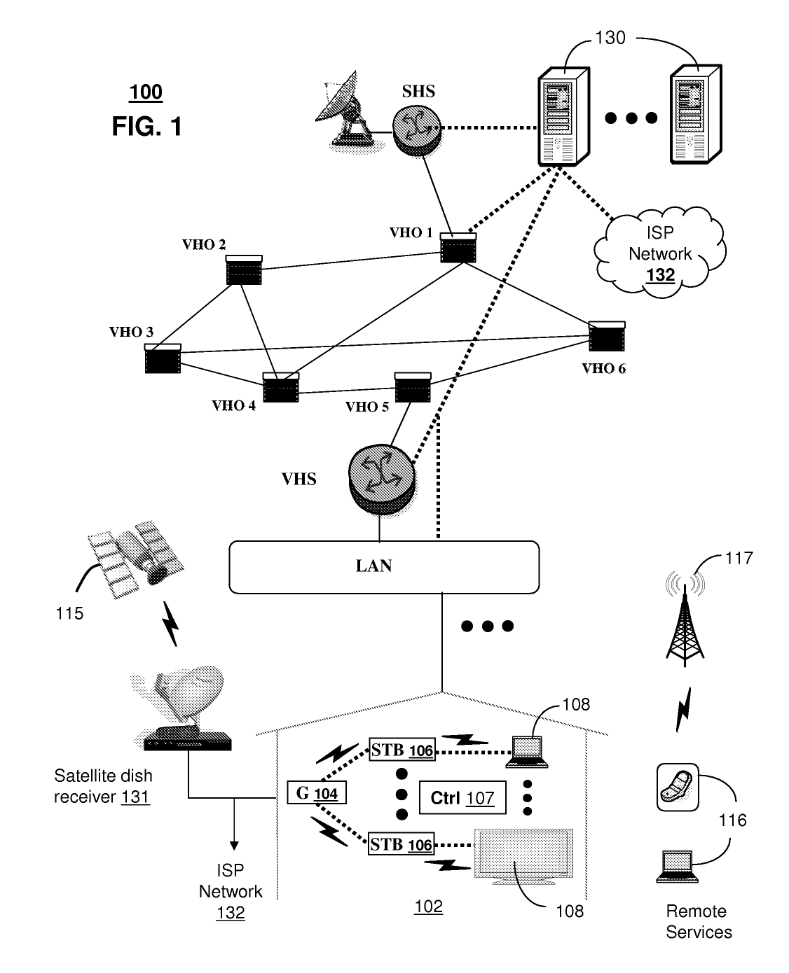

FIG. 1 depicts an exemplary embodiment of a communication system 100. The communication system 100 can represent an IPTV broadcast media system. In a typical IPTV infrastructure, there is at least one super head office server (SHS) which receives national media programs from satellite and/or media servers from service providers of multimedia broadcast channels. In the present context, media programs can represent audio only content, video only content, and/or combinations thereof. The SHS server forwards IP packets associated with the media content to video head servers (VHS) via a network of video head offices (VHO) according to a common multicast communication method.

The VHS then distributes multimedia broadcast programs to commercial and/or residential buildings 102 housing a gateway 104 (e.g., a residential gateway or RG). The gateway 104 distributes broadcast signals to media content processors 106 such as Set-Top Boxes (STBs) which in turn present broadcast selections to media devices 108 such as computers or television units managed in some instances by a media controller 107 (e.g., an infrared or RF remote control). Unicast traffic can also be exchanged between the media content processors 106 and subsystems of the IPTV media system for services such as video-on-demand (VoD).

The IPTV media system can be coupled to one or more computing devices 130 that can operate as a web or Internet server for providing portal services over an Internet Service Provider (ISP) network 132 to fixed media devices 108 or portable communication devices 116 by way of a wireless base station 117 such as in a cellular communication network operating with common protocols (GSM, CDMA, etc.).

A satellite broadcast system can be used in place of the IPTV media system. In this embodiment, signals transmitted by a satellite 115 can be intercepted by a satellite dish receiver 131 coupled to building 102 which conveys media signals to the media content processors 106 by way of gateway 104. The media content processors 106 can be equipped with a broadband port to the ISP network 132. Although not shown, the communication system 100 can also be combined or replaced with analog or digital broadcast distributions systems such as cable systems. It would be apparent therefore to one of ordinary skill in the art that the present disclosure can be applied to any content media system.

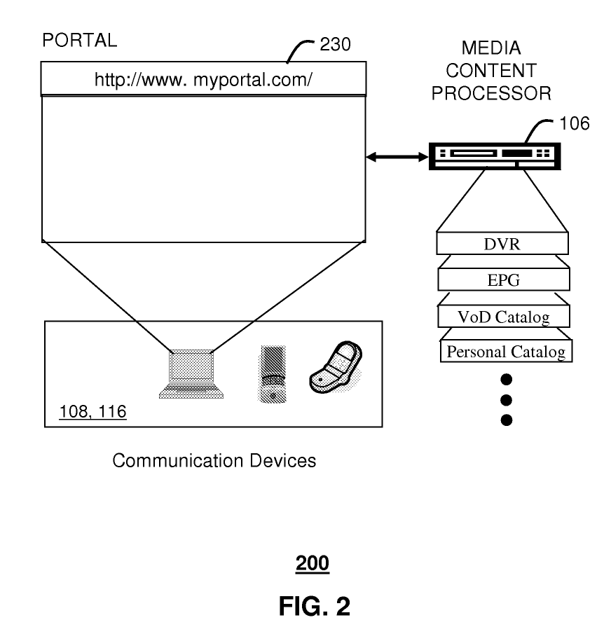

FIG. 2 depicts an exemplary embodiment of a portal 230 of the communication system 100. In FIG. 2, the portal 230 can be accessed by a URL with a common browser such as Microsoft's Internet Explorer using an Internet-capable fixed or portable communication device 108, 116. The portal 230 can be configured to access a media content processor 106 such as the STB of FIG. 1 and services managed thereby such as a Digital Video Recorder (DVR), an Electronic Programming Guide (EPG), Video on Demand (VoD) catalog, a personal catalog stored in the STB (e.g., personal videos, pictures, audio recordings, etc.), and so on by way of the gateway 104.

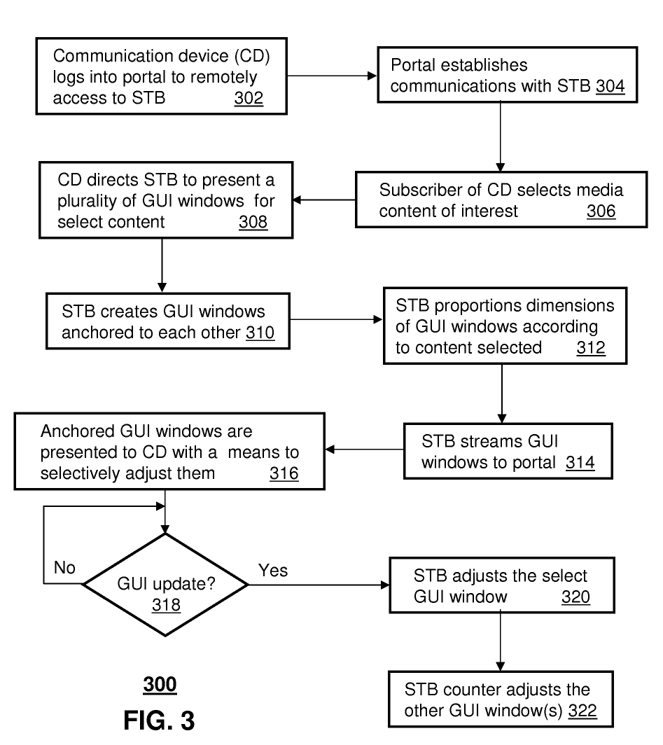

FIG. 3 depicts an exemplary method 300 operating in portions of the communication system 100. Method 300 begins with step 302 in which a subscriber of media content supplied by the STB 106 utilizes a portable communication device 116 to remotely access the STB by way of portal 230. This step can be the culmination of the subscriber invoking a browser of the communication device 116 to log into a specific portal account of the subscriber with a username and password. In step 304, the portal 230 establishes by common means communications with the STB 106 by way of the gateway 104 over the ISP network 132. In step 306 the subscriber can remotely select by way of a user interface of the communication device 116 media content of interest at the STB 106 as if said subscriber were situated in building 102 manipulating operations of the STB with the media controller 107. In step 308 the subscriber can direct the STB 106 by way of the portal 230 to present multiple GUI windows to view the content selected in step 306 (e.g., Picture-in-Picture or PiP, viewing video in or more windows along with an Electronic Programming Guide or EPG). Responsive to this request, the STB 106 in step 310 can create GUI windows anchored to each other that are proportioned contextually in step 312.

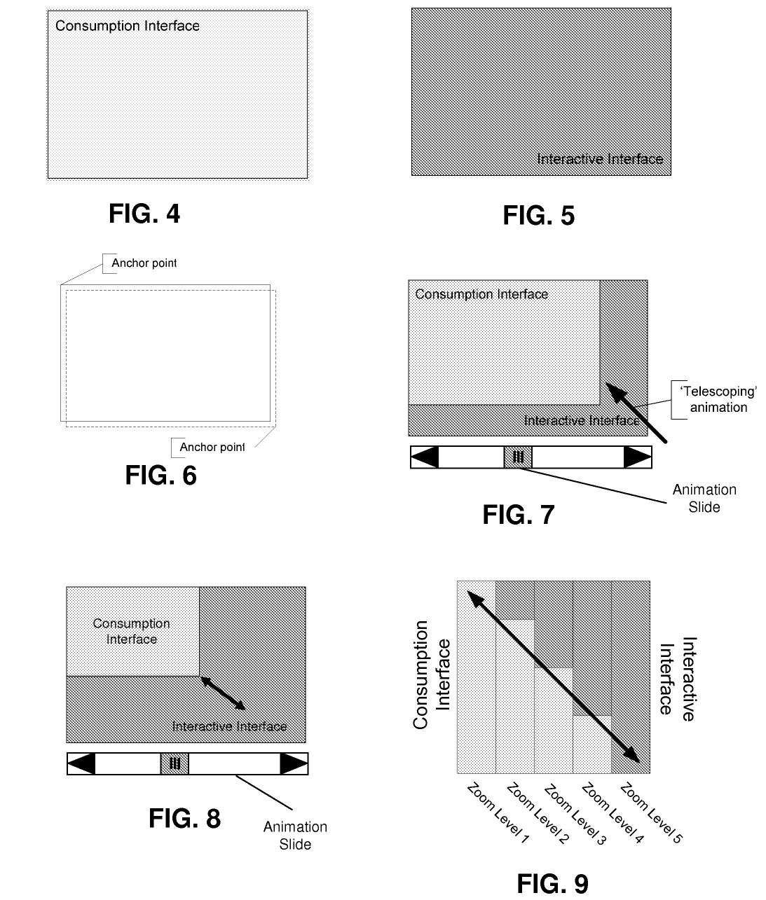

FIGS. 4-9 depict exemplary embodiments of the GUI windows created by the aforementioned steps. GUI windows can have different purposes. For example, a GUI window can be a consumption GUI window as shown in FIG. 4 for viewing video content. A GUI window can also represent a interactive GUI window as shown in FIG. 5 where a subscriber can for example interact with the IPTV media system with an EPG, a VoD catalog, or process Voice over IP (VoIP) or Public Switched Telephone Network (PSTN) phone calls, manage personal media content (e.g., home videos, pictures, etc.), or perform other like interactive activities.

A portion of either of the GUI windows of FIGS. 4 and 5 can be anchored to each other based on anchoring points (or portions) as shown in FIG. 6 so that a dimensional change applied to one window correspondingly changes the dimension of the other window about the portion anchored between them. In addition the initial dimensions and shape of these GUI windows when combined can be determined contextually in accordance with the media content selected by the subscriber for each window. For instance, if the subscriber selects a consumption GUI window for viewing video content, and an interactive GUI window for viewing an EPG, said combination may have adjustable dimensions with shapes as shown in FIG. 7. The consumption GUI window as shown can be shaped a rectangle for widescreen viewing or as a square. The interactive GUI window on the other hand is shaped in proportion to the remaining viewable surface area.

Providing an asymmetric shape to the consumption GUI window can distort or block out portions of video content. By contextually shaping GUI windows a consumption GUI window can be given a dimensional shape that is satisfactory for viewing video content. Since interactive GUI windows present mostly text, providing an irregular shape in this window does not cause apparent distortions since text can be wrapped or repositioned according to the space available. In the case where there are multiple consumption GUI windows, each window can be given the same dimensional shape and can also be vertically or horizontally stacked depending on the preference of the subscriber. An interactive GUI window can also be provided an irregular shape based on the remaining surface area.

As shown in FIGS. 7-8, a portion of the consumption GUI window can be anchored to a corresponding portion of the interactive GUI window. Thus when the consumption GUI window is reduced as shown in FIG. 8, the interactive GUI window expands about the portion anchored therebetween, and vice-versa. Changing the shape of the GUI windows can be accomplished with an animation slide. When the slide is moved to the right or left by common means such as by selection with a mouse and pointer, the consumption and interactive GUI windows can be simultaneously adjusted. That is, as the consumption GUI window is adjusted so that it expands, the interactive GUI window is counter adjusted about the anchoring position so that its surface area is reduced in the overall viewing area. FIG. 9 demonstrates this concept in terms of zoom levels. Each zoom level comprises a proportion between the consumption and interactive GUI windows that adds up to a full-screen presentation of the aggregate GUI windows as a subscriber transitions between zoom levels.

Referring back to method 300 with these principles in mind, the STB 106 can stream the GUI windows created in steps 310-312 to the portal 230 which then presents them to the portable communication device 116 in step 316 with a means to selectively adjust said windows (e.g., animation slide). In step 318, the STB 106 can monitor for a GUI update. If the subscriber makes no changes, the presentation continues with no change to the GUI windows. If an update is detected, the STB 106 proceeds to step 320 where it adjusts the selected GUI window and counter adjusts the other GUI window(s) in step 322 as described earlier.

Upon reviewing the aforementioned embodiments, it would be evident to an artisan with ordinary skill in the art that said embodiments can be modified, reduced, or enhanced without departing from the scope and spirit of the claims described below. For example, an alternative embodiment of method 300 can be applied in cases where the subscriber of the STB 106 is not remotely accessing the STB via the portal 230. In cases where the subscriber is situation in building 102, the subscriber can instead manage the STB 106 with a media controller 107 and generate and manipulate GUI windows as shown in FIGS. 4-9. In this embodiment step 308 can be replaced with a step in which a media controller 107 directs the STB 106 to present multiple GUIs (PiP, video mixed with EPG, etc.) by selecting for example a specialized a “PiP” button or an “info” button on a keypad of said media controller. Steps 310-312 can remain unchanged, while steps 314-316 can be replaced with a step in which the STB 106 presents the anchored GUI windows at a media device 108 such as a TV set. Steps 318-322 can remain unchanged.

Additionally method 300 and its variants can be applied in cases where more than two GUI windows are created. These GUI windows can be shaped and anchored to each other according to the context of the media content being viewed. Also, in place of an animation slide, the subscriber can use common navigation and window manipulation means such as a mouse and pointer to reshape a window while the other window(s) are automatically counter adjusted as described before.

These are but a few examples of modifications that can be applied to the present disclosure without departing from the scope of the claims. Accordingly, the reader is directed to the claims section for a fuller understanding of the breadth and scope of the present disclosure.

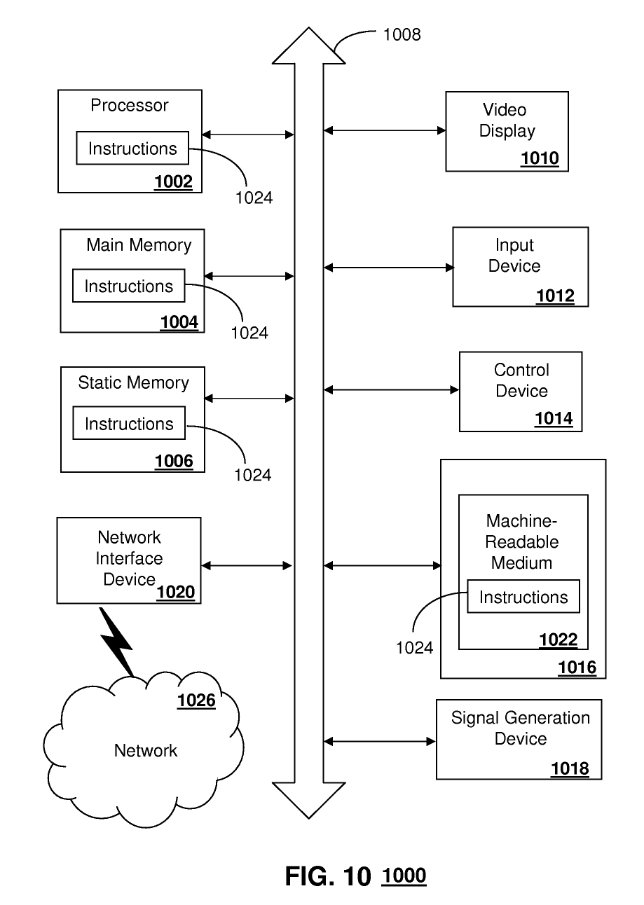

FIG. 10 depicts an exemplary diagrammatic representation of a machine in the form of a computer system 1000 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 1000 may include a processor 1002 (e.g., a central processing unit (CPU), a graphics processing unit (GPU, or both), a main memory 1004 and a static memory 1006, which communicate with each other via a bus 1008. The computer system 1000 may further include a video display unit 1010 (e.g., a liquid crystal display (LCD), a flat panel, a solid state display, or a cathode ray tube (CRT)). The computer system 1000 may include an input device 1012 (e.g., a keyboard), a cursor control device 1014 (e.g., a mouse), a disk drive unit 1016, a signal generation device 1018 (e.g., a speaker or remote control) and a network interface device 1020.

The disk drive unit 1016 may include a machine-readable medium 1022 on which is stored one or more sets of instructions (e.g., software 1024) embodying any one or more of the methodologies or functions described herein, including those methods illustrated above. The instructions 1024 may also reside, completely or at least partially, within the main memory 1004, the static memory 1006, and/or within the processor 1002 during execution thereof by the computer system 1000. The main memory 1004 and the processor 1002 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 1024, or that which receives and executes instructions 1024 from a propagated signal so that a device connected to a network environment 1026 can send or receive voice, video or data, and to communicate over the network 1026 using the instructions 1024. The instructions 1024 may further be transmitted or received over a network 1026 via the network interface device 1020.

While the machine-readable medium 1022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium, comprising computer instructions for:
receiving a presentation request for presenting media content over a consumption Graphical User Interface (GUI) window and an interactive GUI window;
anchoring a portion of the consumption GUI window to the interactive GUI window;
presenting the consumption GUI window and the interactive GUI window;
receiving an adjustment request to adjust a select one among the consumption and interactive GUI windows; and
adjusting according to the adjustment request a first dimension of the consumption GUI window while counter adjusting a second dimension of the interactive GUI window about the anchored portion.

2. The storage medium of claim 1, wherein the consumption GUI window presents video content.

3. The storage medium of claim 1, wherein the interactive GUI window presents an electronic programming guide.

4. The storage medium of claim 1, comprising computer instructions for presenting an animation slide for controlling an adjustment of the consumption and interactive GUI windows.

5. The storage medium of claim 4, comprising computer instructions for:
detecting a movement of the animation slide from information supplied in the adjustment request; and
adjusting the first and second dimensions responsive to said movement of the animation slide.

6. The storage medium of claim 1, comprising computer instructions for zooming into or zooming out of the consumption GUI window while correspondingly performing an opposite zooming effect on the interactive GUI window.

7. The storage medium of claim 1, comprising computer instructions for balancing the first and second dimensions of the consumption and interactive GUI windows.

8. The storage medium of claim 1, comprising computer instructions for varying the dimensions of the consumption and interactive GUI windows according to a type of content presented in each GUI window, wherein the storage medium operates in a media content processor, and wherein the media content processor operates in at least one among an Internet Protocol Television (IPTV) communication system, a satellite TV communication system, and a cable TV communication system.

9. A media content processor, comprising a controller to:
present portions of media content over a plurality of Graphical User Interface (GUI) windows some of which are anchored to each other;
adjust a select one of the plurality GUI windows responsive to receiving a dimensional adjustment request; and
counter adjust a dimension of at least one of the other anchored GUI windows according to the adjusted dimension of the select GUI window.

10. The media content processor of claim 9, wherein at least one of the plurality of GUI windows comprises a consumption GUI window for presenting video content.

11. The media content processor of claim 9, wherein at least one of the plurality of GUI windows comprises a interactive GUI window for presenting an electronic programming guide (EPG).

12. The media content processor of claim 9, wherein the media content comprises at least one among still images, moving images, and audio content.

13. The media content processor of claim 9, wherein the controller is adapted to contextually vary a dimension of each of the plurality of GUI windows presented.

14. The media content processor of claim 9, wherein the controller is adapted to:
present an animation slide for controlling a dimension of at least two of the plurality GUI windows.

15. The media content processor of claim 14, wherein the controller is adapted to:
detect a movement of the animation slide from information supplied in the dimension adjustment request; and
adjust the plurality of GUI windows according to said movement of the animation slide.

16. The media content processor of claim 9, wherein the controller is adapted to zoom into or zoom out of the selected GUI window while correspondingly performing a counter zoom effect on at least one of the other GUI windows.

17. The media content processor of claim 9, wherein the media content processor operates in at least one among an Internet Protocol Television (IPTV) communication system, a satellite TV communication system, and a cable TV communication system.

18. A computer-readable storage medium in a portal, comprising computer instructions for:
presenting at a portable communication device a plurality of Graphical User Interface (GUI) windows some of which have portions of said windows anchored to each other;
receiving from the portable communication device a dimensional adjustment request to be applied to a select one of the plurality of GUI windows; and
presenting at the portable communication device an adjustment to a dimension of the select GUI window and a counter dimensional adjustment to at least one of the other GUI windows according to the portions anchored therebetween.

19. The storage medium of claim 18, comprising computer instructions for establishing communications with a media content processor that presents and adjusts the plurality of GUI windows by way of the portal for viewing at the portable communication device.

20. The storage medium of claim 18, wherein the dimensional adjustment request is generated by an animation slide presented with the plurality of GUI windows and acted upon by the portable communication device.

21. The storage medium of claim 18, wherein a dimension of each of the GUI windows presented at the portable communication device varies according to a type of content presented in each GUI window.

22. The storage medium of claim 19, wherein media content is presented in the GUI windows, and wherein the media content is supplied by at least one among an Internet Protocol Television (IPTV) communication system, a satellite TV communication system, and a cable TV communication system.
